(19) United States
(12) Patent Application Publication
(10) Pub. No.: US 2018/0170642 A1
(43) Pub. Date: Jun. 21, 2018

(54) Reclosable Packaging

(71) Applicant: Amcor Flexibles Burgdorf GmbH, Burgdorf (CH)

(72) Inventors: Ilija Dugonjic, Burgdorf (CH); Martin Rothenbuhler, Langnau I.E. (CH)

(21) Appl. No.: 15/127,492

(22) PCT Filed: Mar. 2, 2015
(86) PCT No.: PCT/EP2015/054290

§ 371 Date: Sep. 20, 2016

(30) Foreign Application Priority Data
Mar. 20, 2014 (EP) 14160951.1

(51) Int. Cl. B65D 75/58; B32B 38/00; B65D 77/20; B32B 37/12

(52) U.S. Cl. CPC B65D 75/5838; B32B 38/0004; B65D 77/2056; B65D 2577/2091; B32B 37/12; B65D 2575/586; B65D 2577/205; B65D 77/2096

(57) ABSTRACT

The present invention is related to a reclosable packaging container comprising a flexible laminate with a build-in opening and reclose feature in the form of a flap, said laminate comprising an inner structure and an outer structure adhesively joined face-to-face by a permanent adhesive, a pattern of pressure-sensitive adhesive being integrated between said inner structure and said outer structure, the pressure-sensitive adhesive being entirely covered by the permanent adhesive, a marginal region delineated by inner and outer score lines comprises the pressure-sensitive adhesive overlaying the permanent adhesive in an imprint region of reduced permanent adhesive thickness, the cumulative thicknesses of the pressure-sensitive adhesive and of the permanent adhesive in the imprint region being substantially the same as the thickness of the permanent adhesive outside this region.

### FIELD OF THE INVENTION

The present invention is related to reclosable packaging containers comprising a flexible laminate with a build-in opening and reclose arrangement, and to a method for the production of this flexible laminate.

### STATE OF THE ART

Flexible packaging materials are used in many applications. Such packaging is obtained by various form fill and seal technologies using laminates of specific constitutions, generally tailor-made for their specific applications.

Flexible laminates are well known in the flexible packaging industry. The laminates are usually obtained by adhesive laminations of one or more polymer films comprising lacquers, barrier layer and metallisation layer, etc. with other possible layers such as paper, metal foils, and the like. The polymer layer may be extruded, coextruded and/or joined by permanent adhesive (PA) and/or pressure-sensitive adhesive (PSA), also called permanent tacky adhesive, to the final laminate.

Flexible packages often contain products that may be used progressively over a longer period of time. If the package is not reclosable, the products are susceptible to premature aging because they are exposed to the moisture of the surrounding environment. It is therefore important to be able to correctly reclose a package after its initial opening to keep the product that remains in the package fresh.

Various build-in opening and reclose arrangements have been developed for flexible packaging containers in the last decades.

The build-in opening and reclose systems of the prior art are obtained by specific score lines performed on both sides of the flexible laminate and delimiting adhesive pattern configurations. Each of those configurations has its specific advantages and drawbacks.

Alusuisse discloses in EP-A1-0957045 (1999) a packaging with a build-in opening and reclose flap obtained by a laminate comprising pattern-applied permanent and pressure-sensitive adhesives in register. The laminate comprises an outer structure and an inner structure. The outer structure comprises a barrier layer. The pressure-sensitive adhesive can be positioned on the inner or outer structure. The permanent and the pressure-sensitive adhesives are both applied on the same inner or outer structure and the score lines are performed separately on the inner structure and on the outer structure of the laminate.

Alcan discloses in EP-A1-1449789 (2004) a packaging with a build-in opening and reclose flap obtained by a laminate comprising an outer structure and an inner structure. In a first embodiment, the laminate comprises pattern-applied permanent and pressure-sensitive adhesives in register, and in a second embodiment a permanent adhesive is applied on the entire surface on the first structure of the laminate and a pattern-applied pressure-sensitive adhesive on the second structure of laminate. In this case, the permanent adhesive and the pressure-sensitive adhesives are superimposed where the PSA is pattern applied and creates a detrimental local increase of thickness entailing a deformation of the produced reel of the laminate. The disclosed outer and inner structures may comprise a series of layers, among them a barrier layer. The pressure-sensitive adhesive can be positioned on the inner or on the outer structure. The permanent adhesive and the pressure-sensitive adhesive are both applied separately on the first and second structures of the laminate. The score lines are performed separately on the inner and outer structures before the structures are joined face to face and form the laminate.

Sonoco discloses in WO 2005/123535 A1 (2005) a packaging with a build-in opening and reclose flap obtained by a laminate comprising pattern-applied permanent and pressure-sensitive adhesives in register. The permanent adhesive does not recover the pressure-sensitive adhesive. The laminate comprises an outer structure and an inner structure, the inner structure comprises a seal layer and a barrier layer, in particular a metallized polymer layer that is able to reflect a laser beam possibly used to perform the score lines. The pressure-sensitive adhesive remains positioned on the flap after a first opening. The permanent adhesive and the pressure-sensitive adhesives are both applied in register on the same first or second structure of the laminate and the score lines are performed on the finished laminate after joining of the inner and outer structures of the laminate.

Sonoco, in a divisional application EP-A1-243716 of WO 2005/123535 A1, claims the replacement of the permanent adhesive by a pressure-sensitive adhesive, wherein the first and second structures of the laminate are joined without using any permanent adhesive.

Wrigley in WO 2008/115693 A1 (2008) discloses a method for making a flexible build-in opening and reclose feature in a laminate comprising pattern-applied a permanent adhesive and a strip of pressure-sensitive adhesive in register in the marginal region between the score lines. The laminate comprises a first structure and a second structure. The first structure is independently scored before joining the second structure and forming a laminate. The second score line is then performed on the laminate.

Printpack Illinois discloses in WO 2010/080810 A1 a reclosable container with build-in opening and reclose feature based on the inner and outer sides of a laminate with a resealable cover portion and a pressure-sensitive adhesive affixing the inner side to the outer side. Here, the basic difference compared to the mentioned prior art before 2010 is that the permanent adhesive is replaced by a heat seal.

Avery Dennison in WO 2011/032064 (2011) discloses a resealable packaging laminate with a build-in opening and reclose arrangement comprising an outer and an inner laminate portion. The outer and inner score lines being arranged to define a marginal region comprising a pressure-sensitive adhesive at least partly in contact with a release layer positioned on the inner layer.

Hochland in EP 2 347 972 A1 (2011) discloses a reclosable packaging, in particular a lid for a tray, with a build-in opening and reclose arrangement comprising a rupturable weakening line in the lid. The lid is obtained by a laminate comprising permanent adhesive in the central area of the lid and pressure-sensitive adhesive in the border area of the lid. The outer structure comprises among other possible layers a barrier layer.

Other laminates, specifically related to cigarette-pack inner or outer wrapper comprising similar build-in opening and reclose arrangements are disclosed by BAT in WO 98/22367 and WO 2008/062159 or by Focke in WO 2011/069575 and WO 2011/110272.

### AIM OF THE INVENTION

The present invention aims to provide an alternative to the existing packages with build-in opening and reclose feature and a method for the production of the laminate presenting specific advantages over the above-mentioned prior art.

### SUMMARY OF THE INVENTION

The present invention discloses a reclosable packaging container comprising a flexible laminate with a build-in opening and reclose feature, said laminate comprising an inner structure and an outer structure, adhesively joined face-to-face by a permanent adhesive, a pattern of pressure-sensitive adhesive being integrated between said inner and outer structures, the pressure-sensitive adhesive being entirely covered by the permanent adhesive, the outer structure forming the outer surface of the container and the inner structure forming the inner surface of the container, the outer structure comprising an outer flap portion delimited by a scoring line through the outer structure, and an inner structure comprising an inner flap portion delimited by a scoring line through the inner structure, the inner score line and the outer score line creating an opening into the container when the flap portions are peeled back, a marginal region of the outer flap portion extending beyond an edge of the inner flap portion and overlying an underlying surface of the inner structure, the inner and outer flap portions being joined with the permanent adhesive and the pressure-sensitive adhesive being disposed between the marginal region of the outer flap portion and the underlying surface of the inner structure for attaching and re-attaching, in use, the outer flap portion to the underlying surface, the permanent adhesive comprising one or more imprints reducing the thickness of the permanent adhesive in the region where the pattern of pressure-sensitive adhesive is located, the added thicknesses of the pressure-sensitive adhesive and of the permanent adhesive in the imprint region being substantially the same as the thickness of the permanent adhesive outside the imprint region.

Preferred embodiments of the reclosable packaging container as in the present invention disclose at least one or a combination of the following features:
one of the inner or outer structures of the laminate additionally comprises a pattern of release coating in an opening-initiation zone adjacent to the pressure-sensitive adhesive pattern, said release coating being entirely covered by the permanent adhesive within the imprint region of permanent adhesive, the added thicknesses of the release coating and of the permanent adhesive in the imprint region being substantially the same as the thickness of the permanent adhesive outside the imprint region;
the release-coating layer is thinner than the pattern-applied pressure-sensitive adhesive;
one of the outer or inner structures has a greater affinity for bonding to the pressure-sensitive adhesive such that the pressure-sensitive adhesive remain entirely with one of the outer or inner structures when the flap portions are peeled back;
the longitudinal edges of the outer structure substantially coincide with the longitudinal edges of the inner structure;
the outer structure includes a layer that is reverse-printed on a surface of the layer facing the inner structure;
the inner structure includes a layer of heat-sealable material;
the inner structure includes a barrier layer providing a barrier against passage of at least one of moisture and oxygen;
the barrier layer comprises a metallized polymer film;
the outer structure comprises a layer of polyethylene terephthalate and the inner structure comprises a multi-layer web comprising a metallized polymer film and a polymeric sealant layer;
the metallized polymer film comprises metallized oriented polypropylene;
the flexible laminate with a build-in opening and reclose feature is a lid.

The present invention further discloses a method for making the flexible laminate of the packaging container as in the present invention, said laminate having a built-in opening and reclose feature, said method comprising the steps of:
pattern-applying a pressure-sensitive adhesive onto one surface of the inner or outer structure;
applying a permanent adhesive onto the entire surface of the inner or outer structure, the layer of permanent adhesive comprising one or more imprints where the permanent adhesive has a lower thickness for the location of the pressure-sensitive adhesive pattern, the added thicknesses of the pressure-sensitive adhesive and of the permanent adhesive in the imprint region being substantially the same as the thickness of the permanent adhesive outside the imprint region;
scoring the inner and outer structures by a scoring station before or after adhesively joining the inner structure to the outer structure face to face via the permanent adhesive to form the laminate, an outer score line being formed through the thickness of the outer structure in registration with the outer perimeter of the pressure-sensitive adhesive, and an inner score line being formed through the thickness of the inner structure in registration with the inner perimeter of the pressure-sensitive adhesive, the marginal region of the outer opening portion between the outer and inner score lines being attached to an underlying surface of the inner structure via the pressure-sensitive.

Preferred embodiments of the method for making the flexible laminate of the packaging container as in the present invention disclose at least one or a combination of the following steps:
pattern-applying a release coating in an opening-initiation zone adjacent to the pressure-sensitive adhesive pattern on one of the outer or inner structures, said release coating being entirely covered by the permanent adhesive within the imprint region, the added thicknesses of the release coating and of the permanent adhesive in the imprint region being substantially the same as the thickness of the permanent adhesive outside the imprint region;
treating one surface of the outer or inner structure with a corona or flame treatment to increase the bonding affinity with the pressure-sensitive adhesive such that the pressure-sensitive adhesive tends to remain adhered to the treated surface when the opening portions are peeled back.

Preferred embodiments of the method for making the flexible laminate of the packaging container as in the present invention disclose at least one or a combination of the following features:
the inner structure comprises a continuous web drawn from a first supply roll and the outer structure comprises a continuous web drawn from a second supply roll, the inner structure being advanced to adhesive and optionally release-coating application stations where the permanent adhesive layer is applied on the entire surface, the layer of permanent adhesive comprising imprint regions for the location of the pressure-sensitive adhesive and optionally the release coating, the pressure-sensitive adhesive and optionally the release coating then being applied on the imprint regions, the inner and outer structures are then adhesively joined in the laminating station;
the adhesive and optionally release-coating layer application stations apply layer of permanent adhesive comprising imprints in register with said pressure-sensitive adhesive pattern and optionally release-coating pattern in a recurring design spaced apart along a length of the inner or the outer structure by an index distance substantially corresponding to a package dimension of the packaging container to be produced with the packaging laminate;
the scoring station forms the score lines at intervals spaced apart along the outer and inner structure, or along the laminate by said index distance.

### BRIEF DESCRIPTION OF THE DRAWINGS

FIG. 1 is a view of the build-in opening and reclose feature with a PSA region surrounding the opening and a release-coating layer region remaining on the inner structure of the laminate after opening.

FIG. 2 is a view of the build-in opening and reclose feature with a PSA region and a release-coating region on the opening initiation (grasping portion), both remaining on the outer structure (flap) of the laminate after opening.

FIG. 3 is a view of a standing pouch comprising a build-in opening and reclose feature as in the invention, where the PSA and the release-coating layer positioned on the opening initiation remains on the outer structure after opening.

FIG. 4 is a view of a flow pack comprising a build-in opening and reclose feature as in the invention, where the PSA and the release-coating layer on the opening initiation remains on the inner structure after opening.

FIGS. 5 and 6 show a tray comprising a build-in opening and reclose arrangement as in the invention on its lid. The PSA and the release-coating layer of the opening initiation remain on the outer structure after opening.

FIG. 7 represents a top view and two profile views according to the axis I-I and II-II of the laminate used for the packaging container as in the invention.

FIG. 8 represents a magnification of the section of the laminate of FIG. 7 in open and closed positions. The permanent adhesive covers the entire surface of the inner structure. In the area where the PSA is pattern applied, the thickness of the permanent adhesive is reduced within an imprint in order to avoid an extra thickness in this specific region. The thickness of the PSA added to the thickness of the permanent adhesive in the imprint region should be substantially the same as the thickness of the permanent adhesive outside the PSA pattern region+possibly the release-coating region/imprint region. In this embodiment, the PSA on the marginal region remains on the inner structure after opening.

FIG. 9 represents the embodiment where the PSA on the marginal region remains on the flap after opening.

FIG. 10 represents a side view of a first lamination arrangement and a top view of the laminate obtained thereby.

FIG. 11 represents a side view of a second lamination arrangement and a top view of the laminate obtained thereby.

FIG. 12 represents a side view of a third lamination arrangement and a top view of the laminate obtained thereby.

FIGS. 13a) and 13b) show a schematic view of two additional embodiments for the production of the laminate of the packaging container of the present invention, wherein two additional positions of the scoring station are disclosed.

FIG. 14 represents a selection of preferred laminate structures contemplated for the packaging container of the present invention.

### KEY

1. Build-in opening and reclose feature
2. Pattern-applied pressure-sensitive adhesive (PSA)
3. Permanent adhesive (PA)
4. Release-coating layer for the opening initiation
5. Scoring line of the outer structure
6. Scoring line of the inner structure
7. Opening initiation (dead zone)
8. Outer structure of the laminate
9. Inner structure of the laminate
10. Barrier layer
11. Seal layer
12. Printed layer
13. Lamination station
14. Oven
15. Scoring station (laser, kiss cutting . . . ) with eye mark/scoring coordination
16. PSA applicator
17. PA applicator
18. Release layer applicator
19. Support film
20. Heat sealable material (lacquer or sealable polymer)
21. Metallized polymer film
22. Metal foil
23. Ink
24. Imprint region
25. Marginal region

### DESCRIPTION OF THE INVENTION

The present invention discloses a flexible packaging container formed by a laminate having a built-in opening and reclose feature 1, the laminate comprising a two-part structure, namely an outer structure 8 joined in face-to-face relation with an inner structure 9. The adjectives “inner” and “outer” are related to the position in the packaging container, the inner structure 9 being in contact with the content of the packaging container and the outer structure 8 being in contact with the environment. Inner and outer structures can also be named first and second structures of the laminate.

At least one of both structures (8,9) comprises a pattern-applied pressure-sensitive adhesive 2 and a permanent adhesive 3 on its entire surface. Once both structures (8,9) are joined by lamination, the patterned pressure-sensitive adhesive 3 is entirely covered by the permanent adhesive 3. In the region covered by both adhesives, the pressure-sensitive adhesive 2 overlays a thinner layer of permanent adhesive 3, said permanent adhesive layer 3 comprising an imprint 24 in order to avoid an extra thickness in this specific region. The global thickness of the PSA 2 added to the thickness of the permanent adhesive 3 is substantially the same as the thickness of the permanent adhesive 3 outside the PSA pattern region (outside the imprint region 24). This avoids the formation of a bump on the reel of laminate.

The inner and outer structures (8,9) of the laminate includes usual lamination structures. The outer structure generally exhibits a printable polymer layer, sometimes associated to a paper layer. Reverse printing is often preferred. Barrier layer 10 such as oriented polyamide (OPA) or EVOH, aluminium foils and the like are usual constituents. The inner structure 9 often comprises a polyolefin seal layer, sometimes associated to support layer, among them oriented polymers like OPP, OPA, OPET, . . . . Substantially all combinations are possible and well known by those skilled in the art.

The number of constituents of a laminate are mainly governed by their specific function in the laminate, by lamination facilities and by price considerations. Technically, almost all combinations are possible.

A score line, defined here as a line of weakness or a trough cut, is formed in the outer structure (outer score line 5) to define an outer opening portion and an inner line of weakness or a trough cut is formed in the inner structure (inner score line 6) to define an inner opening portion. The outer and inner opening portions are attached to each other by a permanent adhesive 3, except in the marginal region 25 that extends beyond the peripheral edge of the inner opening portion between the outer and inner cut or weakening lines, where a PSA pattern is applied and superposed on the thinner permanent adhesive within an imprint 24.

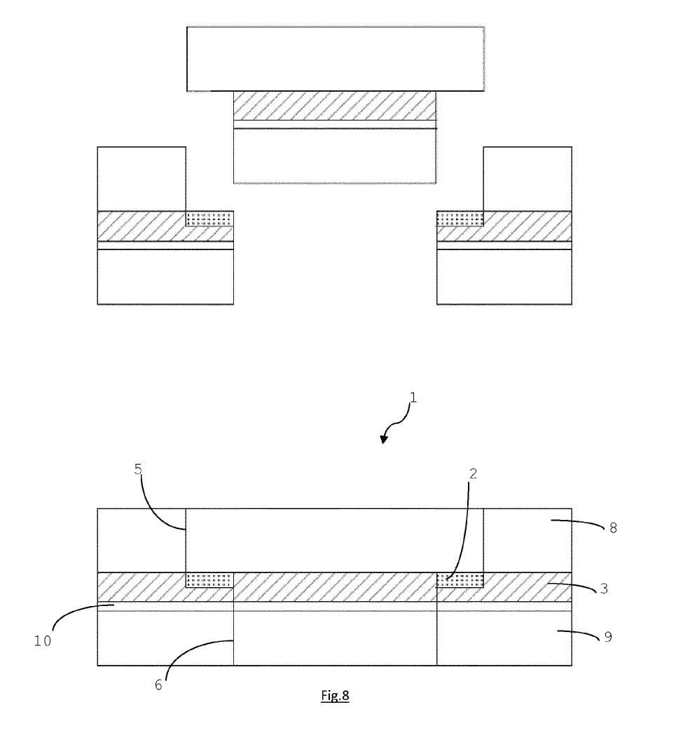

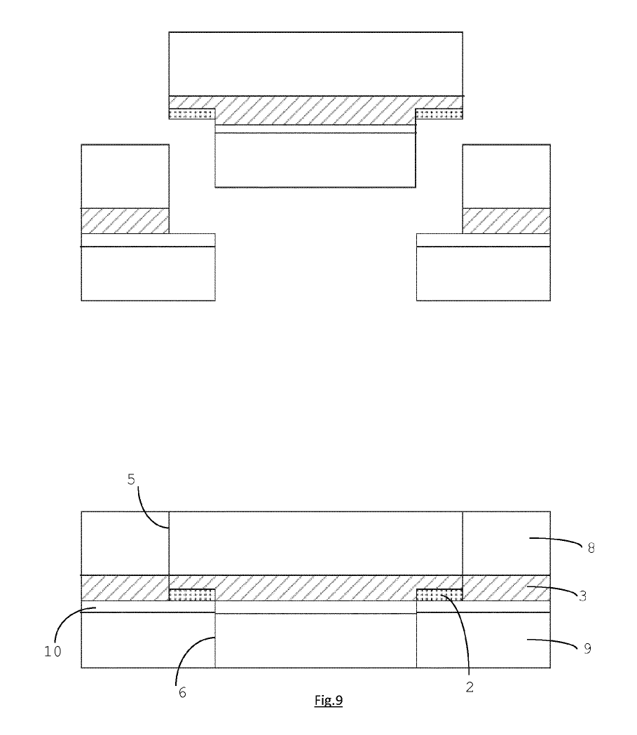

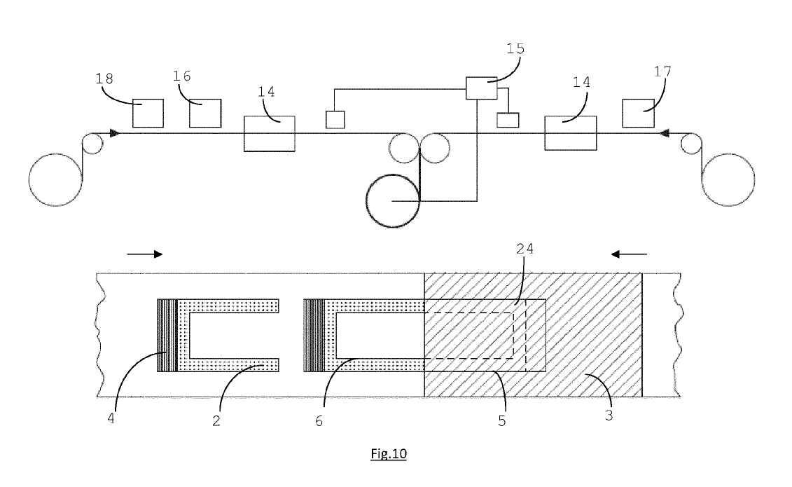

Since the permanent adhesive 3 covers the entire surface of one of the outer or inner structures (8,9), the PSA pattern 2 is covered by the permanent adhesive 3. In the region where the PSA 2 is pattern applied and optionally the release-coating layer 4 is applied, the permanent adhesive comprises an imprint wherein the thickness of the permanent adhesive is reduced in order to avoid an extra thickness in this specific region. The thickness of the PSA 2 added to the thickness of the permanent adhesive 3 is substantially the same as the thickness of the permanent adhesive 3 outside the PSA pattern zone and outside the optional release-coating zone. As shown in FIGS. 8 and 9, the patterned PSA can remain on the first or second structure (8,9) of the build-in opening.

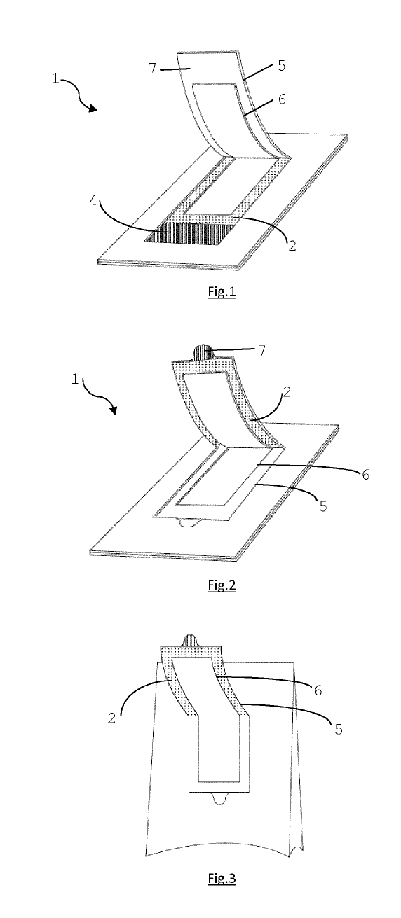

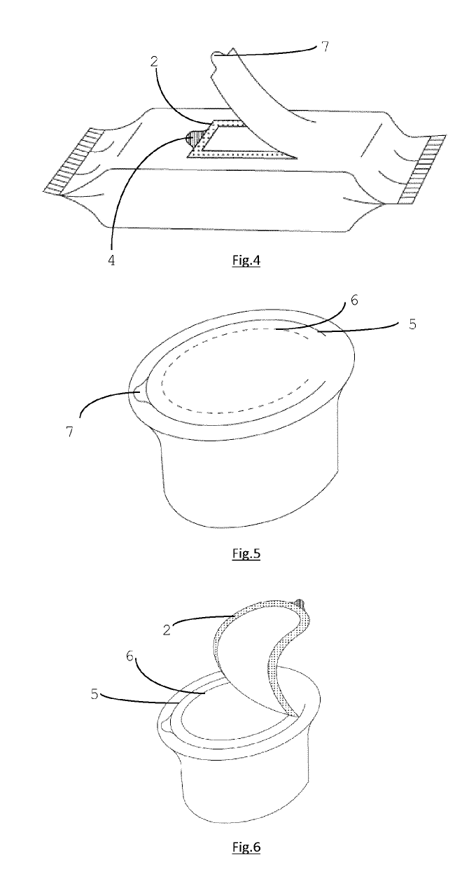

As far as the outer and inner opening portions are connected by a permanent adhesive 3, they can be lifted out of the plane of the build-in opening as a flap, thereby creating an opening through the packaging structure defined by the inner line of weakness (see FIGS. 1 to 6).

After a first opening, the flap created by the connection of the inner and outer portions can be reclosed by adhering the marginal region 25 of the outer opening portion to the underlying portion of the inner structure 9 via the pressure-sensitive adhesive 2. This pressure-sensitive adhesive 2 can be positioned on the outer or the inner structure (8,9), both positions having their advantages and drawbacks. Positioned on the inner structure 9, the PSA is often rapidly contaminated by the content of the package, such as confectionary articles or biscuits, etc. Positioned on the outer structure 8, the PSA 2 is possibly passivized by finger contact. The choice of the position of the PSA 2 is therefore conditioned by the content of the packaging and the requirements of the end-user.

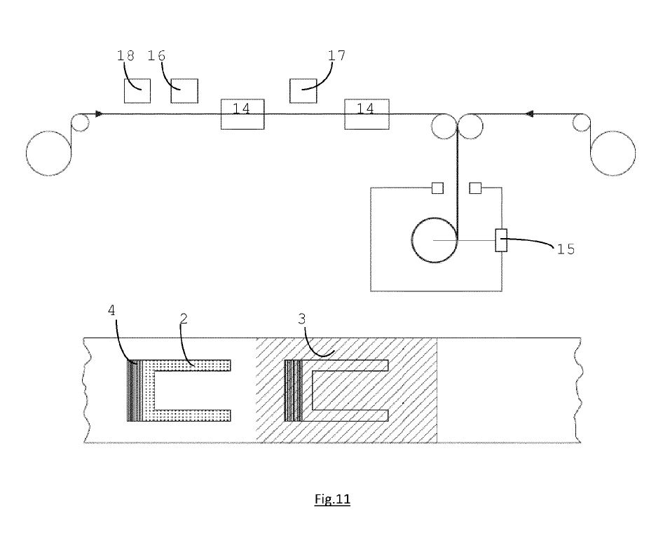

The manufacturing processes of the present invention are shown in FIGS. 10, 11 and 12.

In one embodiment of the invention depicted in FIG. 10, the pressure-sensitive adhesive 2 and the release-coating layer 4 covering the opening initiation 7, are pattern applied onto the inner structure 9 of the laminate, and the permanent adhesive 3 is applied with an imprint 24 onto the other structure 8 over the entire surface, such that the permanent adhesive 3 covers the pattern-applied pressure-sensitive adhesive 2 and release-coating layer 4 in the imprint region 24 once the first and second structures (8,9) are adhesively joined to form the laminate.

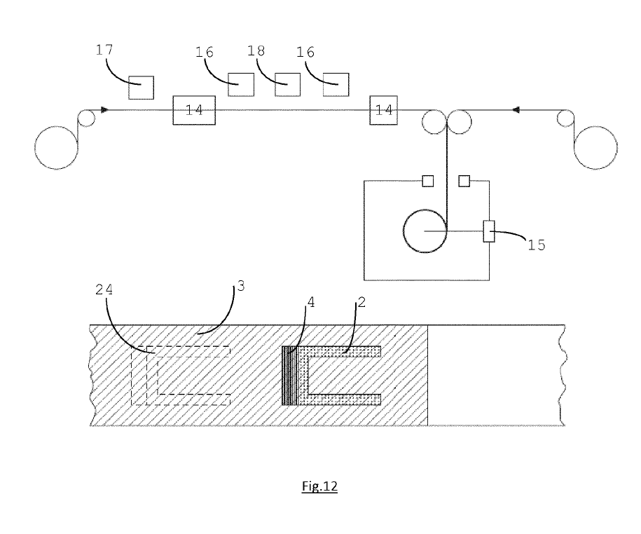

In another embodiment of the invention depicted in FIG. 11, the pressure-sensitive adhesive 2 and the release-coating layer 4 covering the opening initiation 7, are first pattern applied onto one surface of the outer or inner structure (8,9) of the laminate. The permanent adhesive 3 comprising an imprint 24 is then applied over the entire surface of the same structure such that the permanent adhesive 3 covers the pattern-applied pressure-sensitive adhesive 2 and release-coating layer 4, before the first and second structures are adhesively joined to form the laminate.

In an additional embodiment depicted in FIG. 12, the permanent adhesive 3 with its imprint 24 is first applied onto the entire surface of the outer or inner structure (8,9) of the laminate, the pressure-sensitive adhesive 2 and the release-coating layer 4 covering the opening initiation 7 are then pattern applied onto the imprint 24 of the permanent adhesive 3 on the same structure of the laminate before the first and second structures are adhesively joined to form the laminate.

The outer and inner structures (8,9) are preferably supplied from rolls and have substantially the same width. Once laminated face to face, both structures form a laminate that is a continuous web to be supplied to the final packaging station.

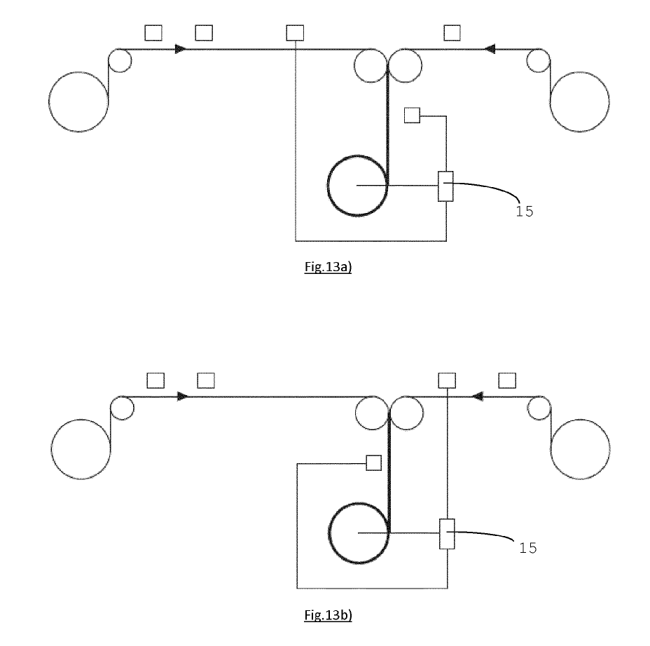

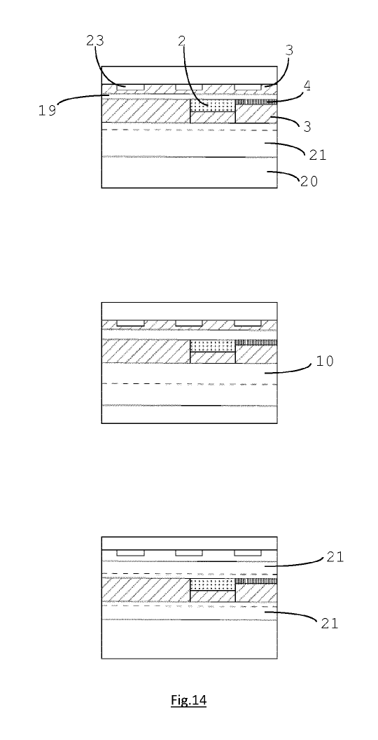

One or both of the inner and outer structures (8,9) or the adhesively assembled laminate are then scored at a scoring station 15 where an outer score line 5 is formed through the thickness of the outer structure 8 in registration with the outer perimeter of the pattern-applied pressure-sensitive adhesive 2 and possibly release-coating layer 4 if an opening initiation 7 is present, and an inner score line 6 is formed through the thickness of the inner structure 9 in registration with the inner perimeter of the pressure-sensitive adhesive layer 2. The score lines (5,6) can be formed by laser scoring, die cutting or kiss cutting, or any other available method well-known in the art. Various scoring positions are disclosed in FIGS. 10, 11 and 13. The position of the scoring station, in case of laser scoring, is principally conditioned by the presence or not of a barrier layer that is able to stop or to reflect the laser beam.

To maintain the outer and inner score lines (5,6) in registration around the PSA and release layer pattern (outer and inner perimeters of both), the scoring operation is synchronized with the advancement of the laminate by means of an optical sensor detecting an eye mark sequence on the laminate, whose location in relation to the pressure-sensitive adhesive 2 and release-coating layer 4 pattern is known.

In case of laser cutting, the depth and width of the score line can be adjusted by regulating the power output of the beam and the residence time of a given spot on the film surface. These parameters are selected in combination with the material to be scored. Some materials are more receptive than others to laser energy—see for instance U.S. Pat. No. 3,909,582 and U.S. Pat. No. 5,158,499 giving extensive information on laser-cutting technology.

Furthermore, various combinations of mechanical and laser scoring are possible. One possibility is for instance to laser-score one side of the laminate and to mechanically cut the other side if one of both structures is not laser-scorable, for instance in the case of a non-absorbing seal layer, such as polyethylene without reflective barrier layer behind.

The adhesives can be applied using any suitable equipment and technique known in the art such as gravure roll for instance. Since the permanent adhesive 3 is applied on the entire surface of at least one part of the laminate, the thickness of the permanent adhesive 3 in the location of the pressure-sensitive adhesive 2 and the release-coating layer 4 is lower than the thickness of permanent adhesive 3 outside the PSA 2 and release-coating layer 4. This thinner part of the permanent adhesive 3 defines an imprint 24. The imprint 24 is located in such a manner that the thickness of the superposed PSA 2/release-coating layer 4 and permanent adhesive 3 remains substantially the same as the thickness of the permanent adhesive 3 outside the location of the PSA 2 and release-coating layer 4 pattern.

In the final laminate, the outer opening portion bonded by the permanent adhesive 3 to the inner opening portion is peelable from the underlying surface of the inner structure 9 allowing both portions to be peeled back and to create a reclosable opening. The marginal region 24 formed between the outer and inner score lines (5,6) on the outer opening portion, is re-attachable to an underlying surface of the inner structure 9 by the pressure-sensitive adhesive 2.

The inner structure 9 of the laminate comprises one or more of a sealant or support layer(s) (19,20) forming the inner surface of the laminate. Sealant layers are well known in the art and comprise heat-seal material such as heat-seal lacquer, LDPE, HDPE, EVA, polypropylene, polyolefin copolymers in general, ionomers or cold-seal materials.

The inner and outer structures (8,9) can also comprise one or more barrier layer(s) 10 known in the art such as metallized polyolefin films, for instance metallized oriented polypropylene (oPP), ethylene vinyl alcohol copolymer (EVOH), oriented polyamide (oPA). Other possibilities are ceramic-coated films like AlOx or SiOx—coated polymer films or aluminium foil.

The outer structure comprises one or more of the following layers:
oriented polypropylene (oPP, 15-40 μm);
high-density polyethylene (HDPE, 15 to 40 μm);
polystyrene (PS, 15-40 μm);
oriented polyamide (oPA, 10-40 μm);
polyester such as polyethylene terephthalate (PET, 10 to 40 μm);
paper.
   The outer layer of the outer structure 8 can be printed outside or reverse-printed.

All the layers of the inside or outside structures (8,9) can be laminated by means of adhesives or coextruded with possible tie layer if necessary. The methods for all possible combinations are known in the art. Some of the preferred structures are represented in FIG. 14.

In the lamination process, the outer structure 8 is provided from a supply roll to a print station for printing graphics and/or indicia on it (not shown). This can be achieved by means of a rotogravure printer. In a preferred embodiment of the invention, the outer structure 8 includes a transparent PET layer that is reverse-printed, which means that the inks are applied to the surface of the PET layer, which is subsequently laminated to another structure, the inks are visible through the first structure by transparency (see FIG. 14).

The surface of the outer structure 8 can be treated by corona discharge or flame treatment just prior to printing in the print station or even in an earlier production step. The corona treatment is typically used in the art to render the surface more receptive to the inks and/or to increase the affinity of the surface to the pressure-sensitive adhesive 2 and to the release-coating layer 4 that is subsequently pattern-applied to the surface (see FIG. 10). The higher affinity to the PSA 2 and the optional release layer coating 4 in case of the presence of an opening initiation 7 is automatically obtained when the PSA/release layer is directly pattern applied on the imprint 24 of the permanent adhesive such as shown in FIG. 12. This is a particular advantage of this embodiment.

After the optional corona and printing operation, the inner and outer structures (8,9) are submitted to application stations of permanent adhesive 3, pressure-sensitive adhesive 2 and release coating 4 in various orders depending on the chosen embodiments.

The embodiment described in FIG. 10 first applies a release pattern and then a pressure-sensitive pattern on the inner structure 9. At the same time, an all-over surface of the permanent adhesive 3 with imprint 24 is applied on the outer surface 8 with a thinner layer of permanent adhesive on the imprint/PSA/release layer location.

The embodiment described in FIG. 11 first applies a release coating 4 pattern and then a pressure-sensitive adhesive 2 pattern on the inner structure 9 followed by an all-over surface of a permanent adhesive 2 with imprint 24 on the same inner structure 9 with a thinner layer of permanent adhesive on the imprint/PSA/release layer location.

The embodiment described in FIG. 12 first applies an all-over surface of the permanent adhesive 3 with imprint 24 on the inner structure 9. The imprint 24 has a thinner layer of permanent adhesive 3 on the future PSA/release layer location. A release-coating pattern 4 and a pressure-sensitive pattern 2 are then applied to the same inner structure 9 on top of the permanent adhesive layer 3 within the imprint 24 and without creating any extra-thickness on this location.

All possible applying combinations can of course be contemplated for the permanent adhesive 3, pressure-sensitive adhesive 2 and release-coating layer 4. Instead of applying the release-coating layer 4 and PSA pattern 2 on the inner structure 9, they could be applied to the outer structure 8 and the permanent adhesive on the inner structure 9. All of them could also be applied to the outer structure 8. The chosen option is irrelevant as long as no extra thickness is created by the overlapping of the PSA/release layer and the permanent adhesive imprint 24. An extra thickness would lead to an undesirable bump or mark on the reel of laminate.

Pressure-sensitive adhesives 2 are also called permanent tacky adhesives and are well known in the art. Pressure-sensitive adhesives 2 can globally be based on latex emulsions (natural rubber, chloroprene, butyl, polybutadiene, isoprene, neoprene . . . ). They can also comprise acrylic adhesives, styrene copolymers (SIS/SBS) and others . . . . Pressure-sensitive adhesives form viscoelastic bonds that are permanently tacky and adhere under simple finger pressure.

The adhesive and release-coating layer 4 applying stations (16,17,18) are complemented by drying means such as ovens or infra-red heater for instance, allowing the applied adhesives to be in good condition for the next manufacture step (lamination or additional application of adhesives or release-coating layer).

The packaging container of the invention comprising the laminates with a build-in open and reclose feature made as in the invention provides a tamper-evidence function because it is very difficult to replace the opening portions after initial opening exactly on the same place as before the opening. When the outer layer of the outer structure 8 is printed, in particular if it is reverse printed, it is almost impossible to achieve perfect registration of the printed matter across the score line when reclosing the package.

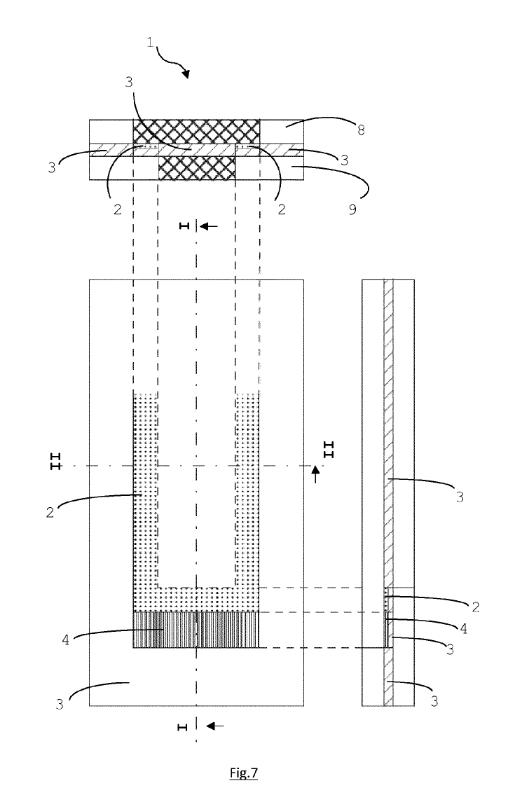

The packages as in the invention not only encompass flow packs or pouches (FIGS. 3 and 4) but also lidding for tray or other container (FIGS. 5 and 6). In this manner, the lid includes a built-in reclosable opening.

### EXAMPLES

### Example 1

Example 1 corresponds to the embodiments shown in FIG. 10 and was performed under the following conditions:

Duplex Structure

A first structure of a white pigmented, oriented polypropylene film (WTD from Treofan Germany GmbH & Co. KG) is printed by means of solvent containing polyvinylbutyral colors (PVB from Siegwerk Druckfarben AG & Co. KGaA). A protection layer of polyamide (Release lacquer 10-609345-3 of Siegwerk Druckfarben AG & Co. KGaA) is then applied on the printed surface. A pressure-sensitive acrylic adhesive (Acronal DS 3556 from BASF) and the same release lacquer is then pattern applied on the virgin side (not printed side) of the polypropylene film.

In the same working step, a second structure of a metallized foamed polypropylene film (QCM from Treofan Germany GmbH & Co. KG) is covered on its entire surface with a solvent containing permanent polyurethane adhesive (Adcote 563 EA/Catalyst F from Dow Chemical Company). On the future positions of the release lacquer and the PSA pattern, the permanent adhesive layer is thinner than outside of these positions (imprints).

The first and the second structure are then adhesive laminated to create a duplex structure. On the backside of the metallized foamed polypropylene, a further cold seal (Naturlex Kautschuk Emulsion—Cold seal S 8085 von Sun Chemical) is pattern applied for the cross and longitudinal seal of the future pack (not represented)

Laser Perforation (ROFIN-BAASEL Lasertech Equipment)

The laser perforation of the duplex structure can performed according to numerous embodiments among which some are represented in FIGS. 10 to 13.

The chosen process essentially depends on the available aging conditions (availability of ovens) and on the available laser equipment.

Preferred embodiments are:
aging for a few days before a laser cut is performed exline first on one side and then on the second side of the duplex structure;
cut inline on both sides of the duplex laminate structure;
separately cut inline the first and second structure before both structures are adhesive laminated to a duplex structure
cut inline one of both structures before the adhesive lamination of both structures followed by the adhesive lamination step and then by the cut of the second structure.

After laser cut of the duplex structure to create the build-in opening and reclose feature for the reclosable packaging of the present invention, the duplex structure is cut into the right width and wound on rolls with the printed layer oriented outside.

### Example 2

In Example 2, Example 1 was reproduced with the same adhesives and release lacquer but all applied on the first structure as shown in FIG. 11.

### Example 3

In Example 3, Example 1 was reproduced with the same adhesives and release lacquer all applied on the first structure after application of the permanent adhesive on the entire surface as shown in FIG. 12.

All examples can additionally be equipped on the duplex structure with a cold seal on specific positions to seal the finished pack. The used cold seal is S 8085 of Sun Chemical. (This step is not represented in the figures.)

Physical Properties

The build-in opening and reclose feature shows first opening force values between 0.5 and 1.5N/15 mm according to ASTM F904:98R08 (former DIN 53357).

1. A reclosable packaging container comprising a flexible laminate with a build-in opening and reclose feature (1), said laminate comprising an inner structure (9) and an outer (8) structure, adhesively joined face-to-face by a permanent adhesive (3), a pattern of pressure-sensitive adhesive (2) being integrated between said inner (9) and outer (8) structures, the pressure-sensitive adhesive (2) being entirely covered by the permanent adhesive (3), the outer structure (8) forming the outer surface of the container and the inner structure (9) forming the inner surface of the container, the outer structure (8) comprising an outer flap portion delimited by a scoring line (5) through the outer structure, and an inner structure comprising an inner flap portion delimited by a scoring line (6) through the inner structure, the inner score line (6) and the outer score line (5) creating an opening into the container when the flap portions are peeled back, a marginal region (25) of the outer flap portion extending beyond an edge of the inner flap portion and overlying an underlying surface of the inner structure (9), the inner and outer flap portions being joined with the permanent adhesive (3) and the pressure-sensitive adhesive (2) being disposed between the marginal region (25) of the outer flap portion and the underlying surface of the inner structure (9) for attaching and re-attaching, in use, the outer flap portion to the underlying surface, the permanent adhesive (3) comprising one or more imprints (24) reducing the thickness of the permanent adhesive (3) in the region where the pattern of pressure-sensitive adhesive (2) is located, the added thicknesses of the pressure-sensitive adhesive (2) and of the permanent adhesive (3) in the imprint region (24) being substantially the same as the thickness of the permanent adhesive (3) outside the imprint region (24).

2. The reclosable packaging container as in claim 1, wherein one of the inner or outer structures (8,9) of the laminate additionally comprises a pattern of release coating (4) in an opening-initiation zone (7) adjacent to the pressure-sensitive adhesive pattern (2), said release coating (4) being entirely covered by the permanent adhesive (3) within the imprint region (24) of permanent adhesive (3), the added thicknesses of the release coating (4) and of the permanent adhesive (3) in the imprint region (24) being substantially the same as the thickness of the permanent adhesive (3) outside the imprint region (24).

3. The reclosable packaging container as in claim 2, wherein the release-coating layer (4) is thinner than the pattern-applied pressure-sensitive adhesive (2).

4. The reclosable packaging container as claim 1, wherein one of the outer or inner structures (8,9) has a greater affinity for bonding to the pressure-sensitive adhesive (2) such that the pressure-sensitive adhesive (2) remain entirely with one of the outer or inner structures (8,9) when the flap portions are peeled back.

5. The reclosable packaging container as in claim 1, wherein the longitudinal edges of the outer structure (8) substantially coincide with the longitudinal edges of the inner structure (9).

6. The reclosable packaging container as in claim 1, wherein the outer structure (8) includes a layer that is reverse-printed on a surface of the layer facing the inner structure (9).

7. The reclosable packaging container as in claim 1, wherein the inner structure (9) includes a layer of heat-sealable material (20).

8. The reclosable packaging container as in claim 1, wherein the inner structure (9) includes a barrier layer (10) providing a barrier against passage of at least one of moisture and oxygen.

9. The reclosable packaging container as in claim 8, wherein the barrier layer (10) comprises a metallized polymer film (21).

10. The reclosable packaging container as in claim 1, wherein the outer structure (8) comprises a layer of polyethylene terephthalate and the inner structure (9) comprises a multi-layer web comprising a metallized polymer film (21) and a polymeric sealant layer.

11. The reclosable packaging container as in claim 10, wherein the metallized polymer film (21) comprises metallized oriented polypropylene.

12. The reclosable packaging container as in claim 1, wherein the flexible laminate with a build-in opening and reclose feature (1) is a lid.

13. A method for making the flexible laminate of the packaging container as in claim 1, said laminate having a built-in opening and reclose feature (1), said method comprising the steps of:
pattern-applying a pressure-sensitive adhesive (2) onto one surface of the inner or outer structure (8,9);
applying a permanent adhesive (3) onto the entire surface of the inner or outer structure (8,9), the layer of permanent adhesive (3) comprising one or more imprints (24) where the permanent adhesive (3) has a lower thickness for the location of the pressure-sensitive adhesive pattern (2), the added thicknesses of the pressure-sensitive adhesive (2) and of the permanent adhesive (3) in the imprint region (24) being substantially the same as the thickness of the permanent adhesive (3) outside the imprint region (24);
scoring the inner and outer structures (8,9) by a scoring station (15) before or after adhesively joining the inner structure (9) to the outer structure (8) face to face via the permanent adhesive (3) to form the laminate, an outer score line (5) being formed through the thickness of the outer structure (8) in registration with the outer perimeter of the pressure-sensitive adhesive (2), and an inner score line (6) being formed through the thickness of the inner structure (9) in registration with the inner perimeter of the pressure-sensitive adhesive (2), the marginal region (25) of the outer opening portion between the outer and inner score lines (5,6) being attached to an underlying surface of the inner structure (9) via the pressure-sensitive (2).

14. The method as in claim 13, comprising the additional step of pattern-applying a release coating (4) in an opening-initiation zone (7) adjacent to the pressure-sensitive adhesive pattern (2) on one of the outer or inner structures (8,9), said release coating (4) being entirely covered by the permanent adhesive (3) within the imprint region (24), the added thicknesses of the release coating (4) and of the permanent adhesive (3) in the imprint region (24) being substantially the same as the thickness of the permanent adhesive (3) outside the imprint region (24).

15. The method as in claim 13, further comprising the step of treating one surface of the outer or inner structure (8,9) with a corona or flame treatment to increase the bonding affinity with the pressure-sensitive adhesive (2) such that the pressure-sensitive adhesive (2) tends to remain adhered to the treated surface when the opening portions are peeled back.

16. The method as in claim 13, wherein the inner structure (9) comprises a continuous web drawn from a first supply roll and wherein the outer structure (8) comprises a continuous web drawn from a second supply roll, the inner structure (9) being advanced to adhesive and optionally release-coating application stations (16,17,18) where the permanent adhesive layer (3) is applied on the entire surface, the layer of permanent adhesive (3) comprising imprint regions (24) for the location of the pressure-sensitive adhesive (2) and optionally the release coating (4), the pressure-sensitive adhesive (2) and optionally the release coating (4) then being applied on the imprint regions (24), the inner and outer structures (8,9) are then adhesively joined in the laminating station (13).

17. The method as in any of claim 13, wherein the adhesive and optionally release-coating layer application stations (16,17,18) apply layer of permanent adhesive (3) comprising imprints (24) in register with said pressure-sensitive adhesive pattern (2) and optionally release-coating pattern (4) in a recurring design spaced apart along a length of the inner or the outer structure (8,9) by an index distance substantially corresponding to a package dimension of the packaging container to be produced with the packaging laminate.

18. The method as in claim 17, wherein the scoring station (15) forms the score lines at intervals spaced apart along the outer and inner structure, or along the laminate by said index distance.
